(19) United States
(12) Patent Application Publication
(10) Pub. No.: US 2003/0078963 A1
(43) Pub. Date: Apr. 24, 2003

(54) Network system and method for automatic posting of digital images

(76) Inventor: Travis J. Parry, Boises, ID (US)

Correspondence Address: HEWLETT-PACKARD COMPANY, Intellectual Property Administration, P.O. Box 272400, Fort Collins, CO, 80527-2400, US

(21) Appl. No.: 10/037,867

(22) Filed: Oct. 24, 2001

(51) Int. Cl. G06F 15/16

(52) U.S. Cl. 709/203; 709/217

(57) ABSTRACT

A system and method of automated posting of an image printed to a sender printer is described. The method includes printing the image on the sender printer. The image is automatically posted to the network site by the sender printer.

This patent application is related to Non-Provisional U.S. Pat. application Ser. No. ______, entitled “Auto Post from a Digital Camera,” having Attorney Docket No. 10006365-1, filed on even date herewith, assigned to the assignee of the present invention, and incorporated herein by reference.

### THE FIELD OF THE INVENTION

The present invention generally relates to a system and method for automated posting of images printed to a sender printer, and in particular, to the automatic posting of images downloaded from a digital camera to a sender printer, which automatically posts the images to a network site.

### BACKGROUND OF THE INVENTION

The Internet is a multimedia computer communications network built on worldwide telephone and data networks. Hundreds of thousands of servers are connected to the Internet, providing a publicly accessible distributed data store. Data is stored on servers in “web pages.” A collection of web pages comprise a “website.” Together these websites form the “World-Wide Web,” or simply the “WEB.” Information held on the WEB and intended for public access is accessible to anyone having a computer connected to the Internet. The WEB search process is known as ‘surfing’. Access to certain information may be restricted by means of closed user groups. A Uniform Resource Locater (URL) has been adopted as a WEB standard to provide a consistent international naming convention to uniquely identify the location of any WEB resource, including photographs, images, programs, recordings, video clips, or documents. URL identified files (web pages) can be located and transferred for reproduction on user equipment connected to the Internet.

Internet Service Providers (ISP) lease server capacity to enable a registered user to establish their own “site” on the Internet, identifiable by a unique URL, to store their own WEB pages (or the WEB pages of others) and make them available to other Internet users. Internet users may access information on the WEB using proprietary WEB browser products running on personal computers (PCs) or workstations linked to the Internet. Automated systems, which retrieve website content are known in the art. This includes, for example, NewspaperDirect® at http://www.newspaperdirect.com, which delivers newspapers stored on web pages to a facsimile machine or printer. Users may subscribe to this news service.

Users often want to share photographs through the Internet, as for example, family wedding photographs or genealogical photographs, etc. Photographs can be digitized by means of a digital camera or a scanner, stored as electronic images, and shared through the Internet via a website or e-mail attachments. Digital cameras utilize image sensor technology and memory storage for capturing and storing images in a digital format. The digital format allows images to be available instantly with no need for a chemical development process necessary for a conventional camera using light-sensitive films. The image is captured utilizing a charge coupled device (CCD) or CMOS (complimentary metal-oxide semiconductor) sensors. Camera electronics are utilized for converting the image into a digital format and storing the image in memory. The number of pictures a user may take is limited by the size and type of memory included in the digital camera. Once the camera memory is full, it can be downloaded to a personal computer or other device and the pictures are deleted from the camera.

Some digital cameras use removable memory storage, typically in the form of a memory card. Once a memory card is full it can be removed from the camera and replaced by another memory card. Also, with additional hardware, memory cards can be inserted directly into a personal computer and photos read to the personal computer similar to accessing a hard disk drive. Once the digital images are downloaded to another medium, the memory card may be re-used. One known removable memory storage is CompactFlash available from SanDisk Corporation. CompactFlash cards weigh very little (approximately 11.4 grams) and are 43×36×3.3 mm. CompactFlash cards are based on flash memory technology and provide non-volatile storage of digital images. Known CompactFlash cards have memory capacities in the range of 4 megabytes to 512 megabytes or higher. Another known removable memory storage is a Smart Media card (also known as SSFDC—solid state floppy disk card) available from Toshiba Corporation. Smart Media cards are smaller and lighter than CompactFlash cards, weighing 0.48 grams with a form factor of 45×37 mm and a thickness of only 0.78 mm. Smart Media cards have a memory storage capacity less than CompactFlash cards, with a known maximum capacity in the range of 16 megabytes. Known higher-end or professional digital cameras may use very small hard disk drives, known as microdrives, as their storage medium. One known microdrive is available from IBM Corporation. The IBM microdrive uses a single one-inch diameter platter that weighs just 16 grams and spins at 4,500 rpms.

Photo finishing companies such as Eastman Kodak® and Ritz Camera® have systems for users to store, share and print photographs. Kodak's® PhotoNet^{SM} Online at http://www.kodak.com operates in conjunction with the ISP, America Online (AOL). A customer's developed film is posted to a website accessed by signing onto AOL and clicking the “You've Got Pictures” button to view the photographs. The photographs can then be e-mailed to friends and family, or printed. Others can be invited to view, download, print, or order high quality reprints. Ritz Camera® has a similar system.

The Ritz Camera® system is described at http://www.ritzcamera.com. Customers are given a password along with their developed film. The customer logs on to the http://www.ritzPIX.com home page and provides their film roll ID number and password, after which their photographs are displayed. Others can be invited via e-mail to view, download, print, or order high quality reprints. Customers can also upload their digital photographs from their computer to a ritzPIX.com storage folder for long-term storage.

The Microsoft Network, through http://communities.msn.com, offers a service whereby a user can establish a site with photographs and send e-mail invitations to others to come and view/download/print the photographs. Users can also subscribe to sites and receive e-mail notices whenever new activity takes place on the site.

In the past, the process of posting images, such as photographic content, involved downloading images from a digital camera or scanner and storing the images on the user's system. Then, once the images are stored on the user's system, manually sending the images to a website such as by creating an e-mail, attaching each stored image to as an e-mail attachment, and then sending the email with the attached images to a network site administrator. To post images, appropriate images files had to be created and selected for each image attached to the e-mail. Not all users are sufficiently proficient with the Internet and personal computers, however, to expeditiously accomplish this process. What is needed is a simple automated system, which will simultaneously post images to a selected website as they are downloaded from a digital camera to a printer.

### SUMMARY OF THE INVENTION

The present invention provides a system and method of automated posting of an image downloaded from a digital camera to a network site. In one embodiment, a sender printer is registered with the network site. The image is transferred to the sender printer for printing. When the sender printer receives the image, the image is automatically posted to the website via the sender printer.

### BRIEF DESCRIPTION OF THE DRAWINGS

FIG. 1 is a block diagram illustrating one exemplary embodiment of a system for printing an image and automatically posting the image to a network site, according to the present invention.

FIG. 2 is a block diagram illustrating one exemplary embodiment of a transfer of a digital image captured via a digital camera to a sender printer.

FIG. 3 is a block diagram illustrating one exemplary embodiment of information flow through a portion of the automated posting system of FIG. 1.

FIG. 4 is a diagram illustrating one exemplary embodiment of a sender interface for use with the automated posting system, according to the present invention.

FIG. 5 is a diagram illustrating one exemplary embodiment of a posting system controller portion of a sender printer.

FIG. 6 is a diagram illustrating one exemplary embodiment of a web access mechanism portion of a sender printer.

FIG. 7 is a flow diagram illustrating one exemplary embodiment of automated posting of an image to a network site according to the present invention.

### DESCRIPTION OF THE PREFERRED EMBODIMENTS

In the following detailed description of the preferred embodiments, reference is made to the accompanying drawings, which form a part hereof, and in which is shown by way of illustration, specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

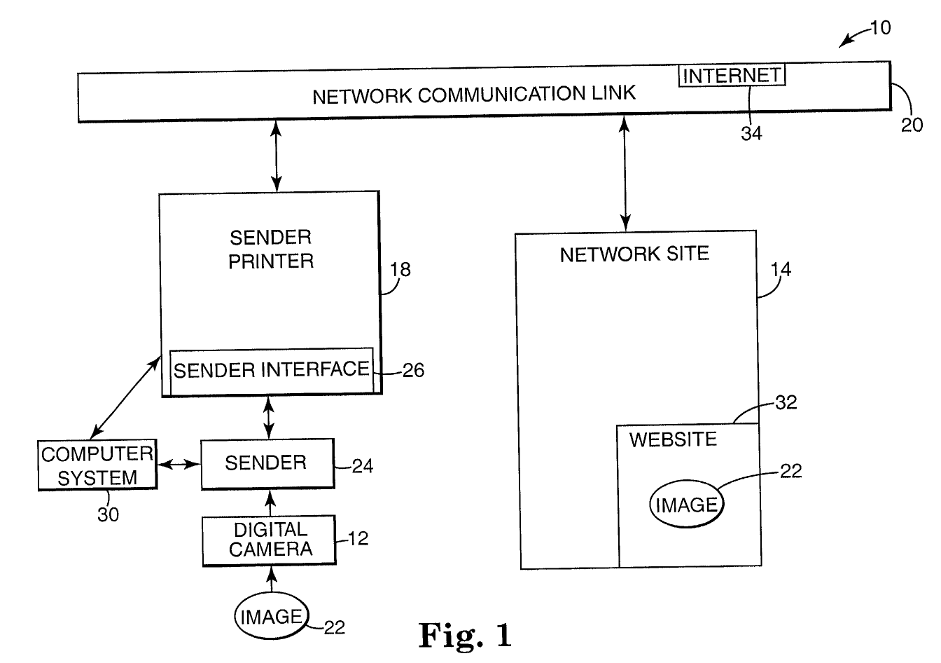

A system and method for automated posting of digital image(s) (i.e., “e-pictures”) captured via a digital camera according to the present invention is illustrated generally at 10 in FIG. 1. Automated posting system 10 automatically transfers an image captured via a digital camera from a sender printer to a network site. In particular, the sender printer automatically posts the image(s) to the network site when the image(s) are transferred to the sender printer for printing.

The term “image,” as used herein, is defined to include a photograph and/or other still or moving digital or electronic image. Image may be one or more images captured via a digital camera. The term “network site,” as used herein, is defined to include a website. Website may be one or more websites to which an image may be posted simultaneously. The term “sender,” as used herein, is defined to include an entity or entities such as a consumer, an employee, or another entity capable of scanning, printing, offering, providing, publishing, and/or downloading an image to an automated posting system according to the present invention. The term “sender printer,” represents a wide variety of devices including devices such as printers, multifunctional printers (MFP's), fax machines, copiers, hardcopy imaging devices, communication and telephony devices. In one preferred embodiment sender printer, as used herein, includes a network-enabled printer with an embedded web access mechanism, and an embedded application. Suitable embedded applications are commercially available under the tradenames ChaiServer Embedded Virtual Machine (EVM) or Java Virtual Machine (JVM), which were developed by Hewlett-Packard and Sun Microsystems, respectively. Other web-enabled printers suitable for use with the present invention will become apparent to those skilled in the art after reading the present application. One exemplary embodiment of a network enabled printer with an embedded web access mechanism is disclosed in detail in this application.

FIG. 1 illustrates one exemplary embodiment of automated posting system 10. In one embodiment, automated posting system 10 includes a digital camera 12, a network site 14 and a sender printer 18. Digital camera 12 communicates with sender printer 18 via a direct or wireless connection. Network site 14 and sender printer 18 communicate with each other via a network communication link 20. Automated posting system 10 operates to automatically post an image 22 to network site 14 when image 22 is transferred from digital camera 12 to a sender printer 18 for printing. In one aspect, a sender 24 posts image 22 to network site 14 via a sender interface 26. Sender interface 26 interacts with sender printer 18 and network site 14 via network communication link 20. In one aspect, posting system 10 operates to simultaneously post image 22 to network site 14 and print image 22 on sender printer 18 without sender 24 having to also download image 22 to a personal computer (PC) and then manually send image 22 to network site 14.

In one embodiment, sender 24 transfers image 22 to sender printer 18 via a computer system 30, which includes an input device such as a keyboard and/or a mouse and a display device such as a monitor, as is known in the art. Computer system 30 communicates with sender printer 18 to enable sender 24 to access sender interface 26. It is, however, within the scope of the present invention for network site 14 to communicate with sender printer 18 in other manners (e.g., via a direct connection or wireless communication link). In one embodiment, sender printer 18 includes sender interface 26, which allows sender 24 to predefine posting options directly through sender printer 18. Sender interface 26 may be located on sender printer 18, or remote from sender printer 18, such as part of computer system 30. Sender printer 18 is registered with network site 14 at website 32. Network site 14, as used herein, includes website 32. While the following description only refers to website 32, it is understood that the use of other network sites is within the scope of the present invention. When sender 24 downloads image 22 from digital camera 12 to sender printer 18 for printing, sender printer 18 automatically posts image 22 to website 32.

Network communication link 20, as used herein, is defined to include an internet communication link (e.g., the Internet), an intranet communication link or other high-speed communication link. In one preferred embodiment, network communication link 20 is capable of transferring HTML files according to the FTP, CGI and HTTP web protocols. In one preferred embodiment, network communication link 20 includes an Internet communication link 34. While the following description refers to Internet communication link 34, it is understood that the use of other network communication links is within the scope of the present invention. In one embodiment, network site 14 and sender printer 18 are located remote from each other. Thus, communications between network site 14 and sender printer 18 are conducted over Internet Communication link 34. It is, however, within the scope of the present invention for network site 14 to communicate with sender printer 18 in other manners (e.g., via a direct or wireless connection).

Automated posting system 10 can be implemented in hardware via a microprocessor, programmable logic device or state machine, in firmware, or in software. In one embodiment, a portion of the software programming is written in JAVA™ programming language and each of the main components communicates via network communication link 20 using a communication bus protocol. For example, the present invention may or may not use a TCP/IP protocol suite for data transport. Other programming languages and communication bus protocols suitable for use with automated posting system according to the present invention will become apparent to those skilled in the art after reading the present application.

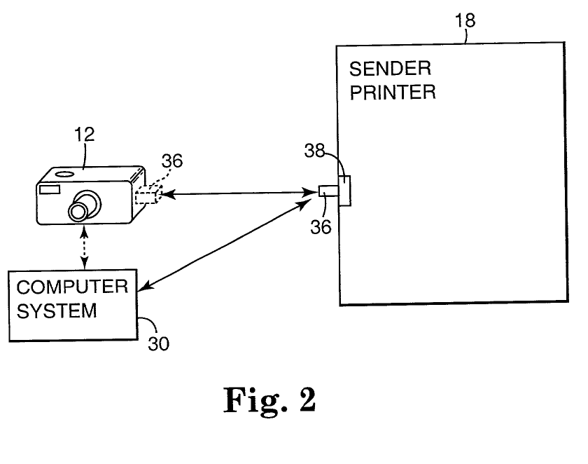

FIG. 2 illustrates one exemplary embodiment of transferring image 22 from digital camera 12 to sender printer 18. In one embodiment, digital camera 12 stores captured images on a removable memory 36. In one aspect, removable memory 36 is nonvolatile memory, which in one embodiment is flash memory. In one embodiment, removable memory 36 is a flash media card, and more preferably a CompactFlash card. Digital camera 12 captures image 22 and stores image 22 as digital image data in removable memory 36 for fast recall and transfer to sender printer 18. Suitable flash memory cards (i.e., a CompactFlash card) are commercially available from memory manufacturers, including SanDisk and Kingston. Other suitable memory cards are commercially available under the tradenames IBM Microdrive, Olympus SmartMedia Memory Card, and Sony Memory Stick. Other suitable removable memory includes a compact disk. In another embodiment, memory 36 is not removable, but located within camera 12 and transferred to computer system 30 or sender printer 18 via a communication link (e.g., wireless or cable). In one aspect, image 22 is transferred to sender printer 18 from digital camera 12 by plugging the memory card into sender printer 18 via a PCMCIA slot.

Removable memory 36 is removed from digital camera 12 and inserted in sender printer 18. Suitable printers are commercially available under the tradename Hewlett Packard PhotoSmart Color Printers, including models P1000, 1100xi, P1215, PS1215, P1218xi, 1215, and 1218. Other suitable printers are commercially available from Hewlett-Packard. In one aspect, removable memory 36 can be “hot-inserted” directly into a removable memory port 38 of sender printer 18. Removable memory 36 includes image 22 as digital image data files. As such, removable memory 36 remains inserted into removable memory port 38 of sender printer 18 during operation of sender printer 18. In one alternate embodiment, image 22 can be transferred (e.g., via a memory download) from removable memory 36 to memory inside of sender printer 18 or computer system 30.

In another embodiment, sender printer 18 receives image 22 by downloading image 22 from a network, via a communication link (e.g., wireless or cable) from another device capable of capturing digital images.(e.g., digital camera, scanner, copier, MFP, etc.), or CD ROM.

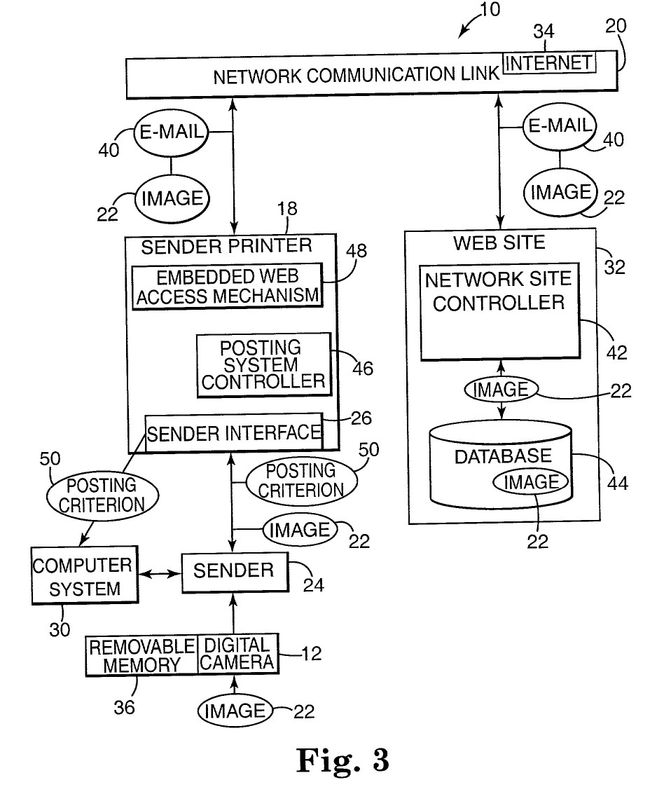

FIG. 3 illustrates one exemplary embodiment of information flow through a portion of automated posting system 10. Sender 24 captures image 22 using digital camera 12 and downloads image 22 to sender printer 18 by transferring removable memory 36 to sender printer 18 as illustrated in FIG. 2. Sender 24 interacts with sender printer 18 via the sender interface 26 to transfer image 22 to sender printer 18. In another embodiment, image 22 is captured directly via computer system 30 (e.g., image e-mailed from another family member, captured from a network, or another device capable of digital imaging). In one embodiment, once image 22 has been received in memory inside of sender printer 18 or computer system 30, automated posting system 10 may immediately post image 22 to website 32 or place image 22 into a queue and post image 22 at a later time according to sender 24's predefined posting options. In one aspect, sender 24 defines and registers multiple websites to which image 22 can be posted simultaneously. In this aspect, sender 24 does not rely on a proprietary site designated by a vender for which the vender is willing to provide service. In one example, digital camera 12 is manufactured by Kodak. Sender 24, using digital camera 12, is able to post image 22 to multiple sites chosen and predefined by sender 24 via sender interface 26 rather than only being able to post image 22 to a site predefined by Kodak. In another aspect, a vender designated posting address can be transferred from digital camera 12 to sender printer 18. The vender designated posting address is then stored as a default address. Sender 24 also has the option of registering the vender designated posting address with sender printer 18 via sender interface 26.

In one embodiment, sender printer 18 interacts with website 32 via Internet communication link 34 to post image 22 to website 32 by sending website 32 an e-mail 40 with image 22 as an attachment. In one alternate embodiment, sender printer 18 posts image 22 to website 32 via a File Transfer Protocol (FTP). The FTP software (e.g., Wsftple.exe) can be installed and run on either computer system 30 or directly from sender printer 18. Sender printer then uploads image 22 to website 32 via the FTP. In another alternate embodiment, sender printer 18 posts image 22 to website 32 via an HTTP post request, which allows sender printer 18 directly to send image 22 to website 32 without regard as to how much data website 32 can accept by transferring image 22 in an input stream. This method allows modifications to data and is not required to be repeatable. Other suitable posting methods for use with the present invention will become apparent to those skilled in the art after reading the present application.

In one embodiment, website 32 includes a network site controller 42 and a database 44. When sender 24 posts image 22 to website 32, image 22 is tracked by website 32 via network site controller 42 and stored in database 44. Once sender printer 18 posts image 22 to website 32, image 22 is stored in database 58, where image 22 may be viewed or downloaded by other network site members when they log on to website 32. In one embodiment, image 22 is transferred to and from database 44, which includes a web page, via network site controller 42. Network site controller 42 includes hardware, software, firmware, or a combination of these. In one embodiment, network site controller 42 includes a computer server or other microprocessor-based system capable of performing a sequence of logic operations. In addition, network site controller 42 can include a microprocessor embedded system/appliance incorporating tailored appliance hardware and/or dedicated single purpose hardware. Network site controller 42 facilitates communication between sender 24 and website 32 by tracking registration of network site members and maintaining a record of images posted to website 32 by sender 24. Examples of database 44 includes non-volatile memory (e.g., a hard disk drive or other persistent storage device) and may include volatile memory (e.g., random access memory (RAM)).

In one embodiment, sender printer 18 includes hardware, software, firmware, or a combination of these. In one embodiment, sender printer 18 also includes sender interface 26, a posting system controller 46 and an embedded web access mechanism 48. In another embodiment, sender interface 26 is run and accessed from computer system 30. Sender 24 interacts with sender interface 26 to define a posting criterion 50 for automated posting of image 22 to network site 14. Posting criterion 50, as described below, identifies attributes specified by sender 24 for posting of image 22 to network site 14 when image 22 is downloaded to sender printer 18 for printing.

Sender printer 18 interacts with website 32 according to posting criterion 50 to post image 22 to website 32. In one aspect, sender printer 18 posts image 22 to website 32 by generating and sending e-mail 40, which includes image 22 as an attachment, to website 32.

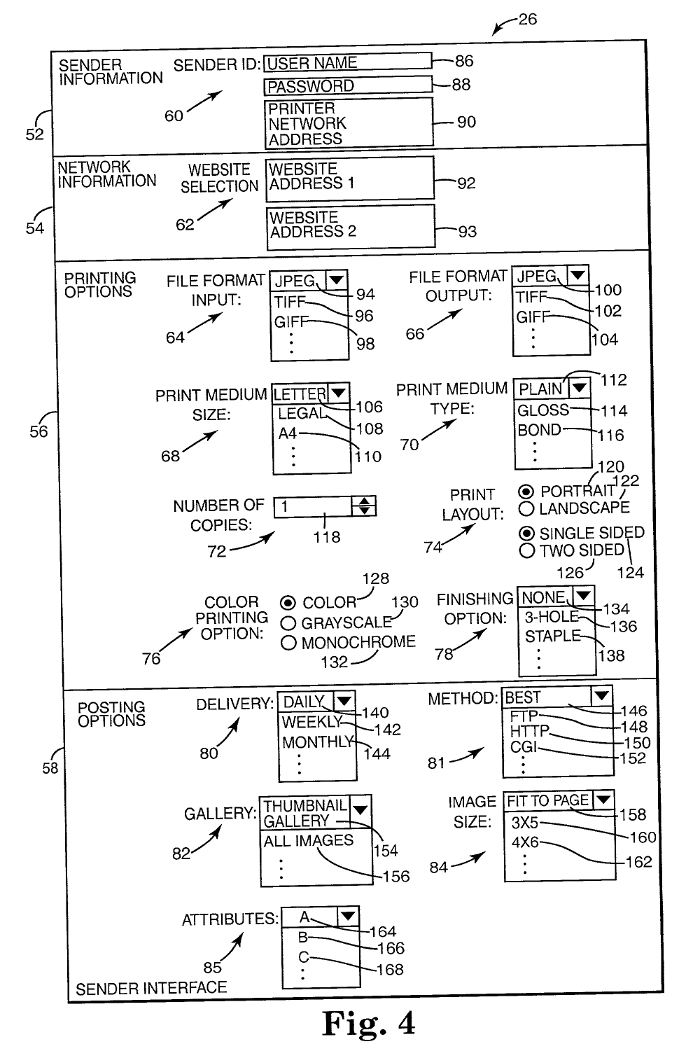

FIG. 4 illustrates one exemplary embodiment of a portion of sender interface 26. In one embodiment, sender interface 26 includes a plurality of input fields with which sender 24 interacts to define posting criterion 50. Sender interface 26 includes a sender information category 52, a network information category 54, a printing options category 56, and a posting options category 58. As such, sender 24 interacts with the input fields, via an input device such as a keyboard and/or mouse of computer system 30, to register posting criterion 50 for automated posting of image 22 to website 32. The input fields include, for example, a sender identification field 60, a website selection field 62, a file format input field 64, a file format output field 66, a print medium size field 68, a print medium type field 70, a number of copies field 72, a print layout field 74, a color printing option field 76, a finishing option field 78, a delivery field 80, a method field 81, a gallery field 82, an image size field 84, and an attributes field 85. The input fields each include at least one subfield providing data entry points or representing available options for simultaneously posting and printing image 22.

Sender information category 52 includes, for example, sender identification field 60 with subfields 86, 88, and 90, which provide data entry points for a user name, password, and printer network address, respectively, of sender 24 and sender printer 18.

Network information category 114 includes, for example, website selection field 62 with subfields 92 and 93, which allow sender 24 to input multiple website addresses to which image 22 is to be posted. The present invention allows sender 24 to post image 22 to multiple websites independent of whether a digital camera manufacturer limits posting services to a particular proprietary site.

Printing options category 56 includes, for example, file format input field 64, file format output field 66, print medium size field 68, print medium type field 70, number of copies field 72, print layout field 74, color print option field 76, and finishing option field 78. File format input field 64 includes, for example, subfields 94, 96 and 98, which represent different file formats for image 22 for posting to website 32. File format output field 66 includes, for example, subfields 100, 102 and 104, which represent different file formats for image 22. Print medium size field 68 includes, for example, subfields 106, 108 and 110, which represent different sizes of print medium for image 22. Print medium type field 70 includes, for example, subfields 112, 114 and 116, which represent different types of print medium for image 22. Number of copies field 72 includes subfield 118 in which a number of copies of image 22 to be printed is specified. Print layout field 74 includes, for example, subfields 120, 122, 124, and 126, which represent different printing layouts for a print job. Color print option field 76 includes, for example, subfields 128, 130 and 132, which represent different color printing options for image 22. Finishing option field 78 includes, for example, subfields 134, 136 and 138, which represent finishing options for image 22.

Posting options category 58 includes, for example, delivery field 80, method field 81, gallery field 82, image size field 84, and attributes field 85. Delivery field 80 includes, for example, subfields 140, 142 and 144, which represent how often sender printer 18 posts image 22 to website 32. Method field 81 includes, for example, subfields 146, 148, 150, and 152, which represent different posting methods used by sender printer 18 to post image 22 to website 32. Gallery field 82 includes, for example, subfields 154 and 156, which represent the type of image 22 to be posted to website 32. Image size field 84 includes, for example, subfields 158, 160 and 162, which represent the size of image 22. Attributes field 85 includes, for example, subfields 164, 166, and 168.

In one embodiment, attributes field 85 allows sender 24 to associate different attributes with image 22, including specifying how the image is to be posted and stored and/or identifying image 22 as part of a particular project or group. In one aspect, once image 22 is associated with sender designated attributes and posted to website 32 (e.g., pictures of son, pictures of vacation, etc.), sender 24 can then log on to website 32 and choose particular attributes common to image 22 to view image 22 and other posted images with similar attributes posted to website 32. In another embodiment, some image 22 attributes are designated by digital camera 12 via image recognition software as is known in the art. In another embodiment, some image 22 attributes are designated by sender printer 18 via image recognition software (e.g., in a digital camera or printer) as is known in the art.

Additional file formats, print medium sizes, print medium types, printing layouts, color printing options, finishing options, method options, delivery options, image sizes, and attributes, as are well known in the art, may be represented by additional subfields of file format input field 64, file format output field 66, print medium size field 68, print medium type field 70, number of copies field 72, printing layout field 74, color printing option field 76, finishing option field 78, delivery field 80, method field 81, gallery field 82, image size field 84, and attributes field 85, respectively. Selecting and/or completing various subfields define posting criterion 50 for automatically posting image 22 to website 32 when it is transferred to sender printer 18 for printing.

It is to be understood that FIG. 4 is a simplified illustration of one exemplary embodiment of sender interface 26. The illustrative presentation of the plurality and input fields including respective subfields, for example, has been simplified for clarity of the invention. The subfields may be presented, for example, as open fields, pull-down menus, toggle selections, and/or highlighted or framed selections. In addition, sender interface 26 may be presented, for example, in one or more screens or views. Furthermore, sender 24 may define posting criterion 50 by responding to query-based systems or applications. It is understood that such alternatives are within the scope of the present invention.

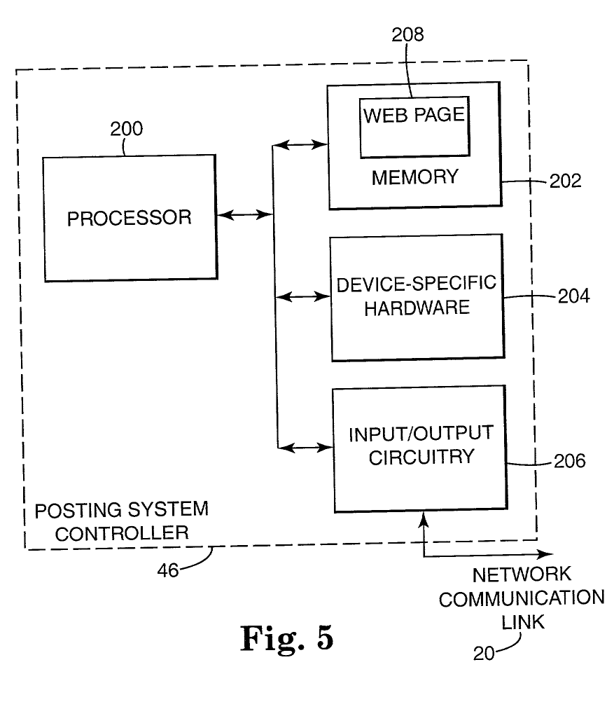

FIG. 5 is one exemplary embodiment of posting system controller 46. In one embodiment, posting system controller 46 includes a processor 200, a memory 202, device-specific hardware 204 (e.g., printer hardware and associated circuitry), and input/output circuitry 206 that enables communication via network communication link 20. Processor 200 in combination with device-specific hardware 204 performs device-specific functions of sender printer 18. In one embodiment, processor 200 stores a printer web page 208 in memory 202, which can also store information about device-specific functions.

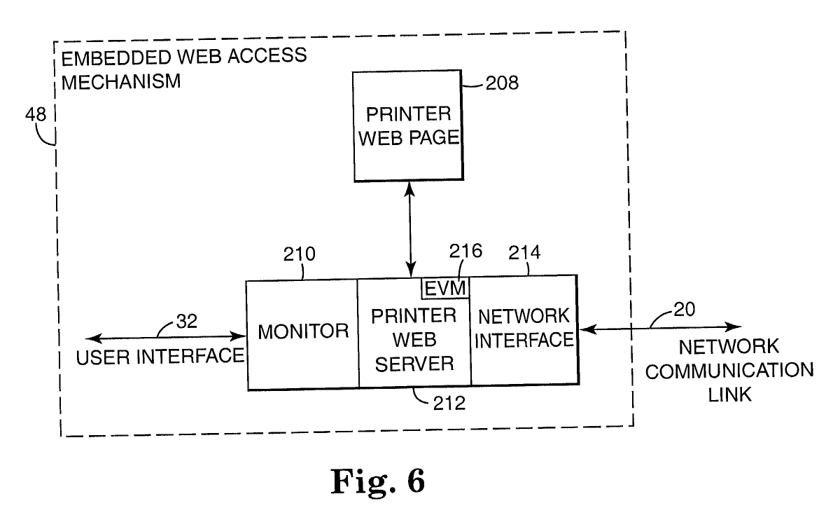

FIG. 6 is a diagram illustrating one embodiment of embedded web access mechanism 48 in sender printer 18, suitable for use with the present invention. Embedded web access mechanism 48 allows the sender printer to communicate with website 32 independent of computer system 30. In one embodiment, embedded web access mechanism 48 includes, for example, a monitor 210, as is known in the art, printer web page 208, a printer web server 212, and a network interface 214. In one embodiment, processor 200 together with software or firmware for processor 200 function as printer web server 212. In one embodiment, the software or firmware for processor 200 that creates web server functionality is a ChaiServer Virtual Machine 216 (hereinafter “EVM 216”). EVM 216 is a programming environment that enables sender printer 18 to execute JAVA™ applications on any processor regardless of an operating system used.

Suitable web access mechanisms for use with the present invention are disclosed in U.S. Pat. No. 5,956,487 to Veukatraman et al. for “Embedding Web Access Mechanism in an Appliance for User Interface Functions Including a Web Server and Web Browser” issued Sep. 21, 1999, and U.S. Pat. No. 6,170,007 to Veukatraman et al. for “Embedding a Web Access Functionality into a Device for User Interface Functions” issued Jan. 2, 2001, both to the assignee in common with the present invention, both of which are hereby incorporated by reference. These patents describe a system by which a device such as sender printer 18 can store and post images to the Web. Web access functionality is embedded in a device to enable low cost widely accessible and enhanced user interface functions for the device. In one embodiment, sender 24 accesses automated posting system 10 by launching printer web page 208. Printer web server 212 provides access to sender interface 26 via printer web page 208. Network interface 214 enables access to printer web page 208 by any web browser such that sender 24 accesses sender interface 26 via printer web page 208 and sender printer 18 posts image 22 to sender printer 18 by sending e-mail 40 to website 32 and interacting with website 32 via network interface 314.

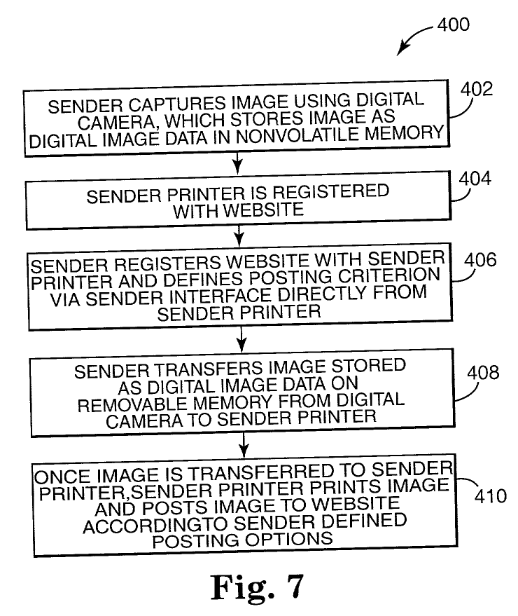

FIG. 7 is a flow diagram illustrating one exemplary embodiment of a method of automated posting of image 22 to website 32. The method of automated posting of image 22 to website 32 according to the present invention is illustrated generally at 400. Reference is also made to FIGS. 1-8. At 402, sender 24 captures image 22 using digital camera 12, which stores image 22 as digital image data on removable memory 36, as illustrated at FIGS. 2. At 404, sender printer is registered with website 32. At 406, sender 24 registers website 32 with sender printer 18 and defines posting criterion 50 via sender interface 26, as illustrated at FIG. 4, directly from sender printer 18. At 408, sender 24 transfers image 22 stored as digital image data on removable memory 50 from digital camera 12 to sender printer 18. At 410, once image 22 is transferred to sender printer 18 from digital camera 12 as illustrated in FIG. 2, sender printer 18 prints image 22 and posts image 22 to website 32 according to sender defined posting options 58.

Preferably, image 22 is posted to and printed on sender printer 18 simultaneously at 412. It is, however, within the scope of the present invention for image 22 to be posted to website 32 before or after it is printed. In addition, it is also within the scope of the present invention for sender printer 18 to queue image 22 and send image 22 according to sender's predefined posting criterion.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of automated posting of an image printed to a sender printer, the method comprising:
printing the image on the sender printer; and
automatically posting the image to a network site via the sender printer.

2. The method of claim 1, comprising defining a communication path between the network site and the sender printer.

3. The method of claim 2, wherein defining a communication path includes defining a network communication link including an Internet communication link.

4. The method of claim 2, wherein defining the communication path between the network site and the sender printer includes registering the network site with the sender printer.

5. The method of claim 2, wherein defining the communication path includes registering the network site with the sender printer, and wherein registering the network site includes defining the network site to be a website.

6. The method of claim 5, wherein defining the communication path further includes defining a unique address associated with the website, and registering the website address with the sender printer.

7. The method of claim 6, wherein defining the website address includes defining the unique address associated with the website as an IP address.

8. The method of claim 2, wherein defining the communication path between the network site and the sender printer includes defining the sender printer to include a posting system controller and a web access mechanism, including a network interface.

9. The method of claim 8, wherein the sender printer automatically posts the image to the network site via the posting system controller and the web access mechanism.

10. The method of claim 1, wherein printing the image on the sender printer includes transferring the image to the sender printer.

11. The method of claim 10, wherein transferring the image to the sender printer includes the sender printer receiving the image via a cable link, a wireless link, CD ROM, or a removable memory.

12. The method of claim 10, wherein the sender printer receiving the image includes removing the removable memory from a digital camera and inserting the removable memory into the sender printer.

13. The method of claim 12, wherein the sender printer receiving the image via the removable memory includes defining the sender printer to include a removable memory port, and wherein the sender printer receiving the image includes receiving the image via the removable memory port.

14. The method of claim 1, wherein automatically posting the image to the network site includes registering the sender printer with the network site.

15. The method of claim 14, wherein registering the sender printer with the network site includes defining a printer network address, and wherein defining the printer network address includes defining a unique address associated with the sender printer and registering the printer network address with the network site.

16. The method of claim 15, wherein defining the network address includes defining the unique address associated with the sender printer as an IP address.

17. The method of claim 1, wherein the sender printer automatically posting the image to the network site includes defining a posting criterion, and wherein defining the posting criterion includes defining posting options for posting the image to the network site.

18. The method of claim 17, wherein defining the posting criterion further includes defining a sender interface, and wherein defining the posting criterion includes defining the posting criterion via the sender interface.

19. The method of claim 17, wherein defining the posting options includes at least one of registering sender information, network information, printing options, and posting options.

20. The method of claim 14, wherein registering the sender printer with the network site includes registering a sender to post the image to the network site.

21. The method of claim 19, wherein registering the sender information includes providing a username and a password of the sender, and the printer network address for the sender printer.

22. The method of claim 5, wherein defining the network site to be a website includes selecting the website via the sender interface, and wherein selecting the website to which the image is to be posted includes registering the website with the sender printer via the sender interface.

23. The method of claim 19, wherein registering the printing options includes selecting at least one of a file format input, a file format output, a print medium size, a print medium type, a number of copies, a printing layout, a color printing option, and a finishing option.

24. The method of claim 19, wherein registering the posting options includes selecting at least one of a delivery, a method, a gallery, an image size, and attributes.

25. The method of claim 1, wherein automatically posting the image to the network site includes sending an e-mail to the network site with the image as an attachment.

26. The method of claim 1, wherein the sender printer automatically posting the image to the network site includes defining the posting of the image to the network site as a direct transfer via a File Transfer Protocol (FTP).

27. The method of claim 1, wherein the sender printer automatically posting the image to the network site includes defining the posting of the image to the network site as a direct transfer via Hypertext Transfer Protocol (HTTP).28.
The method of claim 1, wherein automatically posting the image to the website includes posting the image to the network site via the network communications link according to the posting criterion predefined by the sender.

28. A system for automated posting of an image sent to a printer to a network site, the system comprising:
a sender printer configured to receive the image for printing and automated posting of the image to a website according to a predefined posting criterion.

29. The system of claim 28, wherein the sender printer includes a removable memory port.

30. The system of claim 28, wherein the sender printer includes a posting system controller, an embedded web access mechanism and a sender interface allowing the sender printer to automatically post the image to the website.

31. The system of claim 30, wherein the posting system controller includes a processor, a memory, device-specific hardware, and input/output circuitry; wherein embedded web access mechanism includes a printer web page, a printer web server, and a network interface.

32. The system of claim 30, wherein the embedded web access mechanism allows the sender printer to communicate with the network site regardless of the network site's operating platform.

33. The system of claim 31, wherein the printer web server is adapted to generate the printer web page, wherein the printer web page is configured to provide the sender interface, and wherein the sender interface is configured to provide a control communications link to the posting system controller for defining a posting criterion.

34. The system of claim 28, wherein the sender printer is configured to communicate with the website via a network communications link for automatically posting the image to the network site.

35. The system of claim 28, wherein the sender interface includes a field for defining posting criterion.

36. The system of claim 35, wherein the sender interface posting criterion includes at least one of a delivery option, a gallery option, and an image size field.

37. A system for automated posting of an image sent to a printer to a network site, the system comprising:
a sender printer including a system memory having predefined posting criterion stored therein, and a system controller configured to receive the image for printing and automated posting of the image to a website according to the predefined posting criterion.

38. A computer-readable medium having computer-executable instructions for performing a method of automated posting of an image to a network site, the method comprising:
printing the image on the sender printer; and
automatically posting the image to a network site via the sender printer.

39. A sender interface for use in automatically posting an image, which is printed to a sender printer, to a network site, comprising:
printing options for selecting print criterion for printing the image on the sender printer; and
posting options for selecting posting criterion for posting the image to the network site when the image is received by the sender printer for printing.

40. The system of claim 39, wherein the printing options include at least one of a file format input, a file format output, a print medium size, a print medium type, a number of copies, a print layout, a color printing option, and a finishing option field.

41. The system of claim 39, wherein the posting options include at least one of a delivery, a gallery, and an image size field.

42. The system of claim 39, further comprising at least one of a sender information category that identifies the sender and a network information category that allows registration of the network site with the sender printer.
